(19) United States
(12) Patent Application Publication
(10) Pub. No.: US 2013/0238516 A1
(43) Pub. Date: Sep. 12, 2013

(54) SYSTEM AND METHOD FOR DETERMINING COMPLIANCE WITH MERCHANDISING PROGRAM

(71) Applicant: INVUE SECURITY PRODUCTS INC., Charlotte, NC (US)

(72) Inventors: Andrew W. Moock, Brecksville, OH (US); Phillip Stein, Waxhaw, NC (US)

(73) Assignee: INVUE SECURITY PRODUCTS INC., Charlotte, NC (US)

(21) Appl. No.: 13/788,177

(22) Filed: Mar. 7, 2013

Related U.S. Application Data
(60) Provisional application No. 61/607,802, filed on Mar. 7, 2012.

(51) Int. Cl. G06Q 30/00

(52) U.S. Cl. CPC G06Q 30/018
USPC 705/317

(57) ABSTRACT

A merchandising system and method allow a retailer to determine whether a retail store is in compliance with an electronic retail merchandising program implemented by the retailer. A merchandising display configured to display an item of merchandise at the retail store is provided. A control module is configured to provide information relating to the item of merchandise when a customer interacts with the item of merchandise and to communicate with a network to report data relating to the merchandising display. The retailer may analyze the data obtained from the merchandising system and reported to the network in various ways to determine whether a retail store is in compliance with the electronic retail merchandising program.

### CROSS REFERENCE To RELATED APPLICATIONS

This non-provisional application claims the benefit of United States Provisional Application No. 61/607,802, filed with the United States Patent and Trademark Office (USPTO) on Mar. 7, 2012, which is hereby incorporated by reference in its entirety.

### FIELD OF THE INVENTION

Embodiments of the present invention relate generally to electronic retail merchandising systems used in retail stores. More particularly, embodiments of the present invention relate to a merchandising system and method for determining compliance by a retail store with an electronic retail merchandising program implemented by a retailer. In various embodiments, the merchandising system and method allow a retailer to determine whether a retail store is in compliance with the current electronic retail merchandising program for its retail stores so that the retailer can correct compliance problems occurring at that retail store.

### BACKGROUND OF THE INVENTION

Retailers routinely exhibit items of merchandise, such as mobile (e.g. cellular) telephones, digital music players, game consoles, personal data assistants (PDAs), digital cameras, DSLRs, laptop computers, tablets and the like, for customers to examine before making a purchase. Competing makes, models and/or brands of the same item of merchandise are typically exhibited in proximity to one another so that the customer can readily compare the operation and features of the various items available for purchase. To encourage and assist the customer to make a purchase, retailers often provide information about the items of merchandise at the point of sale. Historically, retailers provided printed information in the form of signs, flyers, brochures and pamphlets available near the items of merchandise. More recently, retailers have begun to provide audio and/or video messages relating to specific items of merchandise at the point of sale. These audio and/or video messages are commonly referred to in the art as “digital signage.” Digital signage may be broadcast on a fairly continuous, repeating basis, sometimes referred to as a “loop.” Preferably, however, digital signage is broadcast when a customer interacts with the item of merchandise. In this manner, a customer receives audio and/or video messages relating the specific item of merchandise being examined.

It is known to position and support an item of merchandise on a merchandising display, such as a display stand or the like, for a customer to view at the point of sale. In the case of electronic items of merchandise, commonly referred to as consumer electronics or electronic devices, it is desirable for the item of merchandise to be removably supported on the merchandising display so that the customer can manipulate the item to examine certain of its features, for example the weight and/or ergonomics of the merchandise. As such, the item of merchandise is typically attached to a mounting structure that is removably supported on a display stand by a tether. The tether limits the distance that a customer can move the item of merchandise from the display stand, and thus, prevents a shoplifter from removing the item of merchandise from the display area without physically detaching the item of merchandise from the mounting structure or severing the tether. Generally, the mounting structure is provided with means for detecting and indicating that the item of merchandise has been detached from the mounting structure in an unauthorized manner and the tether is provided with means for detecting and indicating that the tether has been cut or severed. Monitoring and alarm electronics disposed within the merchandising display are operable with the detecting and indicating means to activate an audible and/or visible alarm in response to a potential theft condition. In some instances, the retailer may also desire to provide electrical power to the item of merchandise so that the customer can evaluate operating features of the merchandise. In such cases, the tether and the mounting structure of the merchandising display typically include one or more additional conductors for delivering electrical power to a power input port of the merchandise so that a rechargeable battery of the merchandise remains charged.

### BRIEF SUMMARY OF THE INVENTION

According to one embodiment of the present invention, a merchandising system is provided. The merchandising system comprises a merchandising display configured to display an item of merchandise at a display position in a retail store. The system also includes a control module operably coupled to the merchandising display, wherein the control module is configured to be in communication with a network and to provide information relating to the item of merchandise when a customer interacts with the item of merchandise. The merchandising display and the control module are configured to report data to a retailer via the network that allows the retailer to determine whether the retail store is in compliance with an electronic retail merchandising program implemented by the retailer.

According to another embodiment of the invention, a method for a retailer to determine whether a retail store is in compliance with an electronic retail merchandising program implemented by the retailer is provided. The method comprises recording data obtained from a merchandising system located at the retail store when the customer interacts with an item of merchandise on display. The method also includes reporting the data obtained from the merchandising system to the retailer and determining whether the retail store is in compliance with the electronic retail merchandising program based on the data obtained from the merchandising system and reported to the retailer.

In another embodiment, a method for determining whether a retail store is in compliance with an electronic retail merchandising program implemented by the retailer is provided. The method comprises receiving data obtained from a merchandising system located at the retail store when the customer interacts with an item of merchandise on display. In addition, the method includes determining whether the retail store is in compliance with the electronic retail merchandising program based on the data obtained from the merchandising system

### BRIEF DESCRIPTION OF THE DRAWINGS

FIG. 1 is an environmental perspective view depicting one embodiment of a merchandising system according to the invention.

FIG. 2 is a schematic diagram illustrating data communications between an Internet portal and the merchandising system of FIG. 1, between the Internet portal and a computer located at a retail store, and between the Internet portal and a computer located at the corporate office of the retailer, according to one embodiment of the present invention.

FIG. 3 is a flowchart illustrating one embodiment of a method according to the invention for determining whether a retail store is in compliance with an electronic retail merchandising program implemented by a retailer.

### DETAILED DESCRIPTION OF EXEMPLARY EMBODIMENTS

From the foregoing, it is apparent that existing merchandising systems are configured to display, secure and power a battery-operated, hand-held electronic item of merchandise and to cause audiovisual information relating to the item of merchandise to be broadcast when a customer interacts with the merchandise. Existing merchandising systems are also configured to allow a retailer to map the same media content to a number of merchandising displays arranged in a particular number and arrangement of display positions, video display monitors, etc. (sometimes referred to as a “planogram”) at different retail stores. However, existing merchandising systems do not provide a method for determining whether a particular merchandising display at a particular retail store is in compliance with the generic planogram and the current electronic retail merchandising program implemented by the retailer at its retail stores.

A common problem for a retailer having multiple retail stores is that individual retail stores often fail to properly execute and comply with the electronic retail merchandising program implemented by the corporate office of the retailer. Unfortunately, merchandising systems currently available to retailers are not capable of identifying the specific item of merchandise that is being displayed at a particular display position. Thus, the corporate office cannot be certain that the item of merchandise on a display position at a particular retail store corresponds to the media content programmed to be broadcast to the customer by the media player. If the item of merchandise being examined by the customer does not correctly correspond to the media content being broadcast by the media player, the merchandising system does not add value to the retailer or to the customer. In fact, the contradictory audiovisual information may detract from the customer experience, and may even discourage the customer from purchasing the merchandise. This undesirable situation may not be corrected until store personnel are made aware of the discrepancy and take corrective action to remove and replace the erroneous merchandise being displayed at the display position with an item of merchandise that corresponds to the media content programmed to be broadcast by the media player for the display position.

In view of the above-noted problems and deficiencies, there is a need for a merchandising system that permits a retailer to determine whether a merchandising display at a retail store is in compliance with an electronic retail merchandising program implemented by the retailer. There is a further need for a merchandising system and method for determining whether a particular merchandise display at a retail store is displaying an item of merchandise that corresponds to the media content programmed to be broadcast to a customer at the retail store for the display position of the merchandising display. There exists a further need for a merchandising system and method that provides the corporate office of a retailer with information to identify a merchandising display at a display position in a retail store that is not displaying an item of merchandise corresponding to the media content programmed to be broadcast while a customer is examining the item of merchandise.

The accompanying drawing figures, wherein like reference numerals denote like elements throughout the various views, show one or more exemplary embodiments of a merchandising system and method for determining compliance by a retail store with an electronic retail merchandising program implemented by a retailer. In the exemplary embodiments provided herein, a merchandising system and method according to one embodiment of the invention provide the corporate office of a retailer with data to identify a merchandising display at a display position in a retail store that likely is not displaying an item of merchandise corresponding to the media content programmed to be broadcast while a customer is examining the item of merchandise. As such, the retailer can utilize the data obtained from the merchandising system and method to correct a compliance problem occurring at a retail store. It is understood that a third party, other than the retailer, may also or alternatively be provided data for determining compliance by a retail store with respect to an electronic retail merchandising program implemented by the retailer (e.g. a marketing agency, merchandise display manufacturer, etc.).

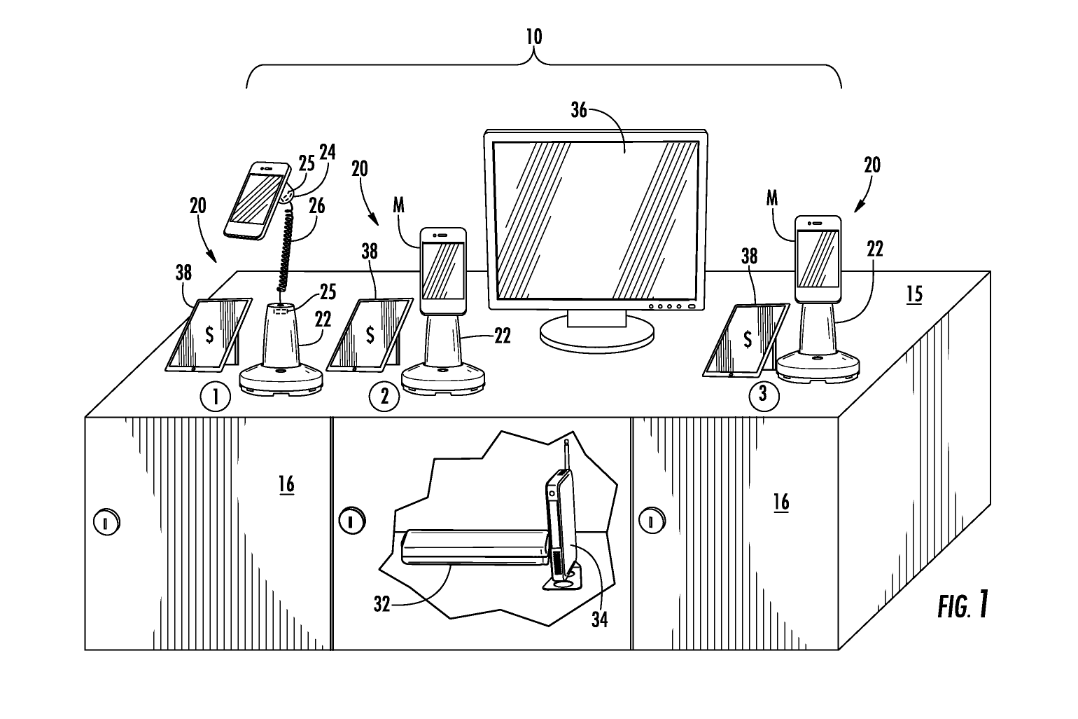

FIG. 1 shows an exemplary embodiment of a merchandising system, indicated generally at 10, according to the invention configured for use with an electronic retail merchandising program. By way of example and not limitation, merchandising system 10 comprises one or more display positions and in some embodiments, a plurality of display positions numbered 1, 2 and 3 on a display support surface 15, such as a display counter, table, shelf, cabinet or the like, for displaying items of merchandise M at a point of sale in a retail store. As shown in FIG. 1, a merchandising display 20 is provided at each display position 1, 2 and 3. The merchandising display 20 may include any display configured to display an item of merchandise M. In one embodiment, the merchandising display 20 depicted is a Series 1000 POD merchandise display stand of a stand-alone alarm system commercially available from InVue Security Products Inc. of Charlotte, N.C. However, various other merchandising displays capable of being configured for use with an electronic retail merchandising system, also commonly referred to as a digital signage system, are suitable for use with the invention. As shown, each merchandising display 20 comprises a base 22 and a sensor 24 that is removably supported on the base. Sensor 24 is mechanically and electrically connected to the base 22 by a multi-conductor electromechanical cable 26 for conducting electrical signals, for example sense loop and electrical power signals, between the sensor and the base. Regardless, an item of merchandise M is physically attached to the sensor 24. In many instances, the item of merchandise M is a battery-operated, handheld electronic device, such as a mobile (e.g. cellular) telephone, digital media players, game console, personal data assistant (PDA), digital camera, or the like, and an electrical cable (not shown), commonly referred to as a power adapter cord, is electrically connected between the sensor and the merchandise in a known manner.

If desired, the sensor 24 may comprise a sensor element, such as a plunger and plunger switch for detecting whether item of merchandise M is in contact with (i.e. remains attached to) the sensor. Consequently, the base 22 may comprise monitoring electronics for monitoring the state of the sensor element and for activating an audible and/or visible alarm in the event that the item of merchandise M is removed from the sensor 24 in an unauthorized manner, such as by a potential thief attempting to steal the item of merchandise. Regardless, the merchandising display 20 further comprises a triggering mechanism or triggering means 25 for indicating that the sensor 24, and consequently the item of merchandise M attached to the sensor, has been lifted or picked up from the base 22. According to one embodiment of the invention herein, the triggering mechanism or triggering means 25 may be a pair of magnets disposed on the base 22 and the sensor 24, respectively. Corresponding detection electronics disposed in base 22 detect a disruption in a magnetic field generated by the sensor 24 being properly positioned and supported on the base that indicates the sensor, and consequently the item of merchandise M, has been removed (i.e. lifted) from the base. However, it is understood that triggering mechanism or means 25 may comprise other electronic or mechanical mechanisms for detecting when the item of merchandise M has been removed from the base 22 or other support surface. With respect to the merchandising system 10, each lifting of the sensor 24 and the item of merchandise M is referred to herein as a “pull.”

The merchandising display 20 at each of the display positions 1, 2 and 3 is operably coupled to an electronic merchandising and media content control module, indicated generally at 30. In the exemplary embodiments shown and described herein, control module 30 comprises a digital interface box (DIB) 32, a media player 34 and a digital monitor 36 of the type provided with the ybuy® digital signage system commercially available from InVue Security Products Inc. of Charlotte, N.C. DIB 22 and media player 34 may be located beneath the display support surface 15 at a convenient location within a lockable cabinet 16 to which access is limited to authorized store personnel. The digital monitor 36 is operably coupled to DIB 32 and media player 34, and is positioned on the display support surface 15 at a convenient location for viewing by a customer interacting with the item of merchandise M attached to the sensor 24 of the merchandising display 20. Merchandising display 20, DIB 32, medial player 34 and digital monitor 36 are in data communication with one another as necessary via electrical cables comprising electrical conductors, or alternatively, via wireless data communications equipment. If desired, an electronic price tag 38 may be likewise operably coupled to the DIB 32 and the media player 34 for displaying information, including for example products specifications, price, sales and/or leasing information, relating to the item of merchandise M being displayed on the corresponding merchandising display 20. As used herein, the term “operably coupled” is intended to include hard-wiring, such as using electrical cables comprising one or more electrical conductors or the like, as well as any wireless communication technology now known or hereafter devised.

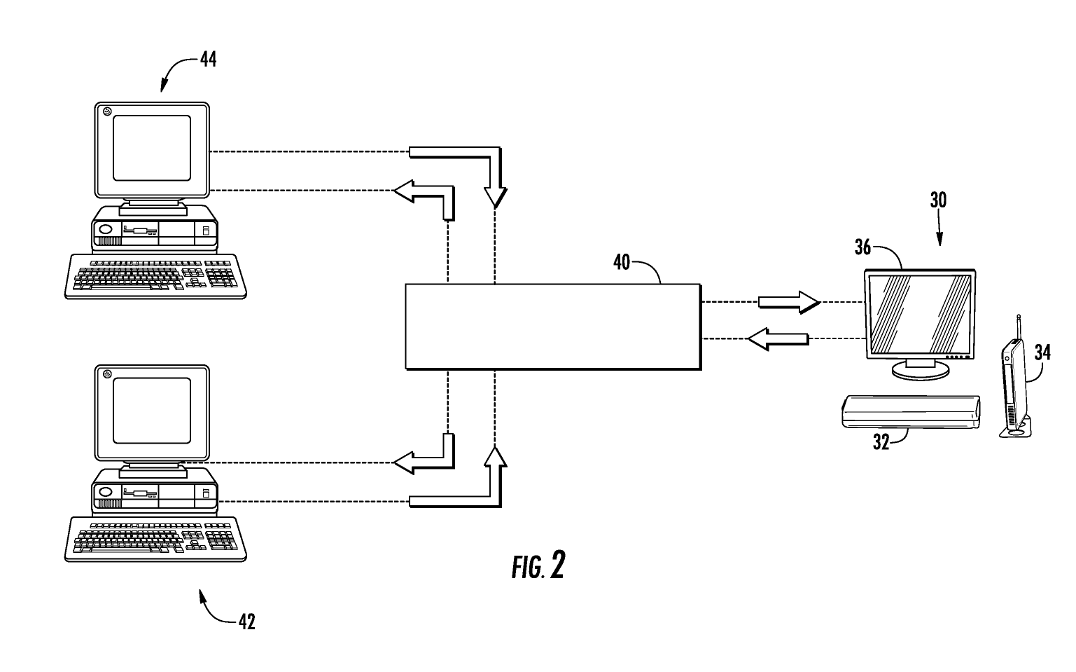

FIG. 2 illustrates data communications between a network, e.g., a global computer network (e.g., Internet portal), indicated generally at 40, and the electronic merchandising and media content control module 30 of the merchandising system 10. As will be readily understood and appreciated by those skilled in the art, the global computer network (e.g., Internet portal) 40 may be in the form of an Internet portal having a Uniform Resource Locator (URL) address for access by a communications device, such as a conventional computer or processing element, having hardware and software operable for exchanging data transmissions with another communications device via the Internet portal in a known manner. However, the global computer network 40 may be any communications network configured for transmitting and receiving data communications between the control module 30 of the merchandising system 10 and a remote digital communications device. FIG. 2 further illustrates data communications between the global computer network (e.g. Internet portal) 40 and a remote computer 42 located at a retailer, and more particularly, at the corporate office of the retailer. FIG. 2 further illustrates data communications between the Internet portal and a remote computer 44 located at a retail store of the retailer.

In the exemplary embodiments shown and described herein, the retailer develops a merchandising system 10 comprising a number and arrangement of merchandising displays 20 for displaying, securing and/or powering items of merchandise M and a corresponding electronic merchandising and media content control module 30, commonly referred to as a “planogram,” to be installed in each of a plurality of similar retail stores located at different physical locations. In addition, the retailer compiles and populates the control module 30 with media content relating to the items of merchandise M and maps the media content to the merchandising displays 20 associated with the items of merchandise M corresponding to the media content. The terms “multimedia content” or “media content” are used herein to mean audio, visual and/or audiovisual information relating to the items of merchandise M being displayed on the merchandising displays 20 of the merchandising system 10. Collectively, the planogram and the media content may define an electronic retail merchandising program to be implemented by the retailer in its retail stores.

In the merchandising system 10 of the invention, the retailer uploads, or “posts,” the electronic retail merchandising program to the Internet portal 40 via data communications between the corporate office computer 42 and the Internet portal. Individual retail stores of the retailer then download, or “pull,” the planogram from the Internet portal 40 via data communications between the retail store computer 44 and the Internet portal. The control module 30, and more particularly the media player 34 at the retail store, then downloads, or “pulls” the media content from the Internet portal 40 via data communications between the retail control module and the Internet portal. As previously mentioned, the electronic retail merchandising program may include a planogram (e.g. the number and arrangement of merchandising displays 20 with specific item of merchandise M thereon) as well as the media content for the control module 30 of the merchandising system 10. Once the merchandising system 10 is installed, the retail store may confirm or verify the electronic retail merchandising program with the corporate office of the retailer via data communications between the retail store computer 44 and the corporate office computer 42 through the Internet portal 40. The retail store computer 44 may communicate additional data, such as the date/time the installation was completed, to the Internet portal 40 and/or the corporate office computer 42. Thereafter, the retail store computer 44 may communicate any change made to the electronic retail merchandising program to the Internet portal 40 or the corporate office computer 42 in the same manner.

Once the electronic retail merchandising program is installed and operating at a retail store, the triggering mechanism or means 25 of the merchandising display 20 detects a “pull” of the sensor 24 and the item of merchandise M being displayed on the merchandising display in the manner previously described. The control module 30 (e.g. DIB 32), records data including, for example, the date/time of each pull, the total number of pulls, the duration of each pull, and the total duration of the pulls. Accordingly, the retailer may analyze the data to determine, for example, the number of pulls over a preselected period of time (e.g. pulls/hour) and the average duration of each pull (e.g. seconds/pull). Additionally or conversely, the DIB 32 may record the lapse of time between successive pulls of the item of merchandise M. An excessively long duration of a pull or between successive pulls may be indicative that the item of merchandise M is not being properly replaced on the base 22 of the merchandising display 20, possibly as a result of damage to the merchandising display. Conversely, an excessively short duration of a pull may indicate that the item of merchandise M does not correspond to the media content being displayed on the digital monitor 36. If desired, the DIB 32 may record and/or calculate other data, for example a loss of electrical power to the merchandising display 20 and/or the item of merchandise M, an armed or unarmed state of the merchandising display, the duration of an unarmed state, an alarm condition, the duration of an alarm condition, etc.

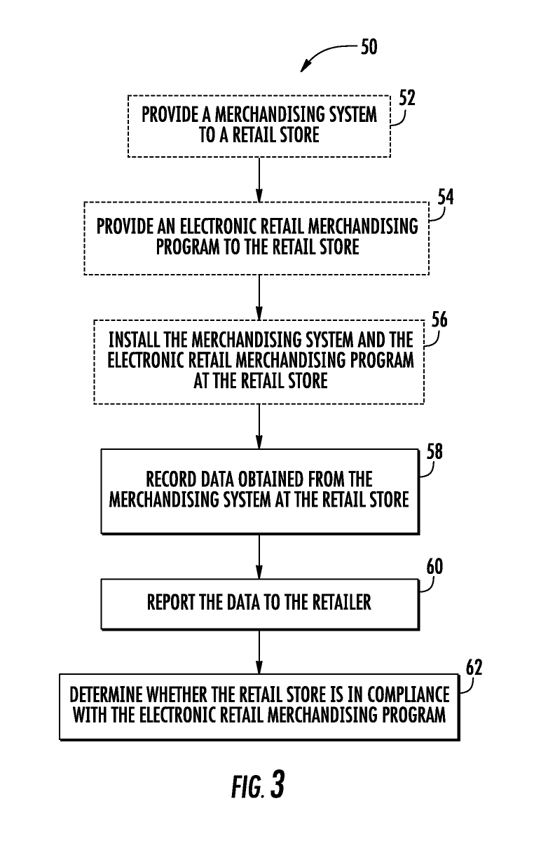

FIG. 3 illustrates an exemplary embodiment of a method, indicated generally at 50, according to the invention for determining whether a retail store is in compliance with an electronic retail merchandising program implemented by a retailer. In a first optional step indicated at 52, the retailer provides a merchandising system 10 as previously described to a retail store. In a second optional step indicated at 54, the retailer provides an electronic retail merchandising program to the retail store. As previously described, the electronic retail merchandising program may comprise a planogram of a plurality of merchandising displays 20 configured for displaying, securing and/or powering a corresponding plurality of items of merchandise M. In a third optional step indicated at 56, the merchandising system 10 and the electronic retail merchandising program are installed at the retail store. Once the merchandising system 10 and the electronic retail merchandising program are installed, the retail store may confirm and/or verify the electronic retail merchandising program with the retailer and report the date and time that the merchandising system is operational. In a fourth step indicated at 58, the control module 30 of the merchandising system 10 records data obtained from the merchandising system, and more particularly, from the merchandising display 20. In step 60, the control module 30 reports preselected data to the retailer. In a fifth step indicated at 62, a determination is made whether the retail store is in compliance with the electronic retail merchandising program implemented by the retailer by analyzing the data from the merchandising system 10 reported to the retailer.

The data recorded by the control module 30 of the merchandising system 10 may be used by the retailer in various ways to determine compliance by a retail store with the electronic retail merchandising program. For example, the merchandising display 20 may detect, the DIB 32 may record and the media player 34 may report that an item of merchandise M is attached to a merchandising display 20 at a display position that is not included in the planogram, and consequently, for which the electronic retail merchandising program is not programmed to broadcast media content when a customer interacts with the merchandise. As such, the retailer may conclude that the retail store is displaying the item of merchandise at an incorrect display position, or that the retail store has installed the merchandising system 10 with incorrect items of merchandise M at display positions for which media content is being broadcast to the customer.

In another example, the control module 30 may detect, record and report that an item of merchandise M previously attached to a sensor 24 of a merchandising display 20 has not been detached by sales personnel (i.e. in an authorized manner) for a period of time that exceeds the time period specified by the planogram of the electronic retail merchandising program. As such, the retailer may conclude that the retail store has not updated the item of merchandise M consistent with the media content provided for the display position by the electronic retail merchandising program. Accordingly, the retailer may determine compliance by the retail store with the electronic retail merchandising program by querying the reporting data uploaded, or “pushed,” to the Internet portal 40 by the media player 34 of the control module 30. Specifically, the retailer may query the reporting data of a particular retail store for a listing of the products currently being displayed on the merchandising displays 20 and the date that the product was put on display to identify display positions displaying an item of merchandise M that has not been changed within the time period specified by the electronic retail merchandising program.

In another example, the merchandising system 10 and the Internet portal 40 may be used by the retailer via data communications between the corporate office computer 42 and the Internet portal to detect, record and report the total number of product changes that have occurred over a period of time. Specifically, the retailer can query the reported data for a listing of the retail stores and the number of product changes made at each retail store over a given period of time. As such, the retailer may determine that a particular retail store is not in compliance with the electronic retail merchandising program implemented by the retailer.

In yet another example, the retailer may use data detected, recorded and reported by the merchandising system 10 to the Internet portal 40 and obtained via data communications between the corporate office computer 42 and the Internet portal to identify specific items of merchandise M that are being displayed at display positions in fewer than a preselected number of retail stores. Specifically, the retailer can query the reported data for a listing of products that are being displayed in fewer than the preselected number of retail stores cross-referenced with the retail stores to identify retail stores that may be displaying obsolete items of merchandise. As such, the retailer may determine retail stores that are not in compliance with the current electronic retail merchandising program implemented by the retailer.

In yet another example, the retailer may use data detected, recorded and reported by the merchandising system 10 to the Internet portal 40 and obtained via data communications between the corporate office computer 42 and the Internet portal to identify retail stores having more than a preselected number of display positions. Specifically, the retailer can query the reported data for a listing of retail stores having more than the preselected number of open positions to identify retail stores that have not been provided with the items of merchandise specified by the electronic retail merchandising program, or alternatively, that are not in compliance with the current electronic retail merchandising program implemented by the retailer.

In other examples, the merchandising system 10 and the method 50 of the invention may be used by the retailer to identify: 1) items of merchandise M, or products, that are not being displayed at a display position in each of the retail stores; 2) products that are being displayed at a display position in a retail store that should not be currently on display; 3) discontinued products that remain displayed at a display position in a retail store; and 4) products displayed at a display position in a retail store for which media content is programmed to be broadcast when a customer interacts with the product wherein the merchandising system 10 has not detected, recorded and reported a “pull” event within a preselected period of time period, and as such, indicates a product may not in fact be attached to the merchandising display 20 at the display position. In addition, the system 10 and method 50 according to embodiments of the invention may be used to obtain reporting data and analyze the reported data to compare the products being displayed at display positions in the various retail stores and thereby identify retail stores that may not be in compliance with the electronic retail merchandising program being implemented by the retailer.

In still other examples, the system 10 and method 50 according to embodiments of the invention may be configured and used to provide analytics to the corporate office of the retailer for analyzing the operation and/or effectiveness of the electronic retail merchandising program in a particular retail store. Specifically, the DIB 32 and the media player 34 of the control module 30 may be configured to record and report merchandise pulls; alarm conditions; change-outs (i.e. item detachments and item attachments); power interruptions (i.e. a power adapter cord being plugged into and unplugged from an item of merchandise); loss of data from a specific display position; etc. Furthermore, the merchandising system 10 may further comprise a camera (not shown) that is activated to record intermittent or continuous images of a display position in response to any of the aforementioned events. As previously discussed, the aforementioned data detected, recoded and reported by the merchandising system 10 may be utilized by the corporate office of the retailer to determine that a specific display position, and consequently, a particular retail store is not in compliance with the electronic retail merchandising program currently being implemented by the retailer to educate potential customers about the items of merchandise on display at its retail stores.

The foregoing has described one or more exemplary embodiments of a merchandising system and method for determining compliance by a retail store with an electronic retail merchandising program implemented by the retailer. The exemplary embodiments of the merchandising system shown and described herein include a merchandising display configured for displaying, securing and/or powering an item of merchandise and an electronic merchandising and media content control module configured for providing information relating to the item of merchandise to a customer. The exemplary embodiments of the method shown and described herein include recording and reporting data obtained from the merchandising system and analyzing the data to determine whether the retail store is in compliance with the electronic retail merchandising program. As a result, the retailer can utilize the data obtained from the merchandising system to correct a compliance problem occurring at a retail store. Exemplary embodiments of a merchandising system and method according to the invention have been shown and described herein for purposes of illustrating and enabling the best mode of the invention. Those of ordinary skill in the art, however, will readily understand and appreciate that numerous variations and modifications of the invention may be made without departing from the intended broad scope of the invention. Accordingly, all such variations and modifications are intended to be encompassed by the appended claims.

That which is claimed is:

1. A merchandising system comprising:
a merchandising display configured to display an item of merchandise at a display position in a retail store; and
a control module operably coupled to the merchandising display, the control module configured to be in communication with a network and to provide information relating to the item of merchandise when a customer interacts with the item of merchandise;
wherein the merchandising display and the control module are configured to report data to a retailer via the network that allows the retailer to determine whether the retail store is in compliance with an electronic retail merchandising program implemented by the retailer.

2. A merchandising system according to claim 1, wherein the merchandising display comprises a base configured to be secured to a support surface and a sensor removably supported on the base, and wherein the item of merchandise is attached to the sensor.

3. A merchandising system according to claim 2, wherein the merchandising display comprises triggering means for indicating that the sensor and the item of merchandise have been removed from the base.

4. A merchandising system according to claim 3, wherein the triggering means comprises magnets disposed on the base and the sensor that define a magnetic field when the sensor is supported on the base.

5. A merchandising system according to claim 1, wherein the control module comprises a digital interface box (DIB) and a media player operably coupled to the DIB and to a digital monitor that is configured to display the information relating to the item of merchandise to the customer.

6. A merchandising system according to claim 5, wherein the media player is configured to obtain the information provided to the customer from the electronic retail merchandising program implemented by the retailer via the network.

7. A merchandising system according to claim 6, wherein the information comprises media content relating to the item of merchandise.

8. A merchandising system according to claim 1, wherein the merchandising display is configured to detect when a customer interacts with the item of merchandise, and wherein the control module is configured to provide the information to the customer in response to the merchandising display detecting the customer interacting with the item of merchandise.

9. A merchandising system according to claim 1, wherein the network is an Internet portal, and wherein the control module is in bi-directional communication with the Internet portal.

10. A method for a retailer to determine whether a retail store is in compliance with an electronic retail merchandising program implemented by the retailer, the method comprising:
recording data obtained from a merchandising system located at the retail store when the customer interacts with an item of merchandise on display;
reporting the data obtained from the merchandising system to the retailer; and
determining whether the retail store is in compliance with the electronic retail merchandising program based on the data obtained from the merchandising system and reported to the retailer.

11. A method according to claim 10, further comprising detecting when a customer interacts with the item of merchandise and providing information relating to the item of merchandise when the customer interacts with the item of merchandise.

12. A method according to claim 11, further comprising displaying the information relating to the item of merchandise to the customer.

13. A method according to claim 10, further comprising obtaining the electronic retail merchandising program from the retailer.

14. A method according to claim 10, further comprising reporting the data obtained from the merchandising system over a network to a remote location from the retail store.

15. A method according to claim 10, wherein reporting comprises reporting at least one of the date/time when a customer interacts with the item of merchandise, the total number of times a customer interacts with the item of merchandise, the duration of each time a customer interacts with the item of merchandise, or the total duration of the total number of times a customer interacts with the item of merchandise.

16. A method according to claim 10, wherein determining comprises at least one of identifying an item of merchandise that has not been changed by the retail store within a preselected period of time, identifying an item of merchandise that has been changed fewer than a preselected number of times by the retail store within a preselected period of time, identifying an item of merchandise that is being displayed in fewer than a preselected number of retail stores, or identifying a number of display positions at the retail store not displaying an item of merchandise that is greater than a preselected number.

17. A method according to claim 10, further comprising installing the merchandising system at the retail store.

18. A method according to claim 10, further comprising installing the electronic retail merchandising program at the retail store.

19. A method for determining whether a retail store is in compliance with an electronic retail merchandising program implemented by the retailer, the method comprising:
receiving data obtained from a merchandising system located at the retail store when the customer interacts with an item of merchandise on display; and
determining whether the retail store is in compliance with the electronic retail merchandising program based on the data obtained from the merchandising system.
